(19) United States
(12) Patent Application Publication
(10) Pub. No.: US 2006/0279239 A1
(43) Pub. Date: Dec. 14, 2006

(54) Apparatus and method for controlling motor

(75) Inventor: Ho-bin Hwang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/440,072

(22) Filed: May 25, 2006

(30) Foreign Application Priority Data
Jun. 8, 2005 (KR) 10-2005-0048841

(51) Int. Cl. H02P 7/00

(52) U.S. Cl. 318/268

(57) ABSTRACT

An apparatus and method for controlling a motor are provided, in which a speed measuring unit measures the rotational speed of a motor at various positions during an experimental revolution of the motor; a speed change detecting unit detects changes in the rotational speed of the motor at the various positions of the rotating motor due to a cogging torque based on the measured rotational speed; a speed storing unit stores the measured rotational speed for the various positions of the rotating motor in addresses corresponding to the various positions of the rotating motor; and a motor control unit controls the rotational speed of the motor at the various positions of the rotating motor based on the stored rotational speed. Accordingly, the speed and the position of the motor can be precisely controlled, and print quality deterioration in an image forming apparatus due to rotational speed ripples can be avoided.

### CROSS-REFERENCE TO RELATED PATENT APPLICATION

This application claims the benefit under 35 U.S.C. § 119(a) of Korean Patent Application No. 10-2005-0048841, filed on Jun. 8, 2005, in the Korean Intellectual Property Office, the entire disclosure of which is hereby incorporated by reference.

### BACKGROUND OF THE INVENTION

1. Field of the Invention

The present invention relates to controlling a motor. More particularly, the present invention relates to an apparatus and method for controlling a motor by experimentally rotating the motor, detecting changes in the rotational speed of the motor due to a cogging torque, and correcting the rotational speed of the motor when the motor is in various positions.

2. Description of the Related Art

A cogging torque in an electric motor is caused by a change of magnetic flux owing to the position of a rotor.

FIG. 1 is a graph illustrating rotational speed with respect to a position of a motor controlled by a conventional motor control apparatus and method. The conventional motor control apparatus and method feedback a difference between a reference speed 100 and a real rotational speed 150 of the motor in order to control the motor to rotate at a constant speed.

However, problems may exist in the conventional motor control apparatus and method in which the real rotational speed 150 of the motor is not maintained constant due to a cogging torque, and ripples in the real rotational speed 150 are produced, as shown in FIG. 1.

The conventional motor control apparatus and method cannot precisely control the speed and the position of the motor due to the cogging torque. Also, since a motor used in an image forming apparatus operates at low speed, print quality deteriorates due to ripples.

Accordingly, there is a need for an improved motor control apparatus and method that controls rotational speed and position of a motor.

### SUMMARY OF THE INVENTION

An aspect of exemplary embodiment of the present invention is to address at least the above problems and/or disadvantages and to provide at least the advantages described below. Accordingly, an aspect of exemplary embodiments of the present invention is to provide an apparatus and method for controlling a motor by experimentally rotating the motor, detecting changes in the rotational speed of the motor due to a cogging torque, and correcting the rotational speed of the motor when the rotating motor is in various positions.

According to an aspect of exemplary embodiments of the present invention, there is provided an apparatus for controlling a motor, in which a speed measuring unit measures the rotational speed of a motor at various positions during an experimental revolution of the motor; a speed change detecting unit detects changes in the rotational speed of the motor at the various positions of the rotating motor due to a cogging torque based on the measured rotational speed; a speed storing unit stores the measured rotational speed for the various positions of the rotating motor in addresses corresponding to the various positions of the rotating motor; and a motor control unit controls the rotational speed of the motor at the various positions of the rotating motor based on the stored rotational speed.

In an exemplary implementation, the speed change detecting unit calculates an average value of the rotational speed measured during the experimental revolution of the motor, and calculates a difference between the average value and the measured rotational speed to detect changes in the rotational speed.

In another exemplary implementation, the speed change detecting unit calculates a difference between a reference speed for the control of the motor and the measured rotational speed to detect the changes in the rotational speed.

In still another exemplary implementation, the motor control unit comprises a reference speed correcting unit that corrects a reference speed for the control of the motor based on the stored rotational speed at the various positions of the rotating motor; and a rotational speed control unit that controls the rotational speed at the various positions of the rotating motor based on the corrected reference speed.

In a further exemplary implementation, the reference speed correcting unit corrects the reference speed using the rotational speed measured at respective positions of the rotating motor using the following equation,
V_{new}=V_{ref}−A*Dif[n % N]

where V_{new} denotes a new reference speed after correction, V_{ref} denotes the reference speed before correction, A denotes a constant, n denotes a current position of the motor, N denotes a number of divided positions of the rotating motor, and Dif[n % N] denotes the measured rotational speed corresponding to the current position of the rotating motor.

In an exemplary implementation, the speed measuring unit may read a plurality of divided parts on a wheel mounted around a rotating axis of the motor by an encoder to measure the rotational speed of the motor.

In another exemplary implementation, when power is applied to the motor, the speed measuring unit may measure the rotational speed at the positions of the rotating motor during one revolution of the motor.

According to another aspect of exemplary embodiments of the present invention, there is provided a method of controlling a motor, in which the rotational speed of the motor rotating is measured at various positions during an experimental revolution of the motor; changes in the rotational speed of the motor at the various positions due to a cogging torque are detected using the measured rotational speed; the measured rotational speed for the various positions of the rotating motor are stored in addresses corresponding to the various positions of the rotating motor; and the rotational speed of the motor at the various positions of the rotating motor are controlled based on the stored rotational speed.

In an exemplary implementation, the detecting of the rotational speed comprises calculating an average value of the rotational speed measured during the experimental revolution of the motor, and calculating a difference between the average value and the measured rotational speed to detect changes in the rotational speed.

In another exemplary implementation, the detecting of the rotational speed comprises calculating a difference between a reference speed for the control of the motor and the measured rotational speed to detect the changes in the rotational speed.

In still another exemplary implementation, the controlling of the rotational speed comprises a reference speed for the control of the motor that is corrected based on the stored rotational speed at the various positions of the rotating motor; and the rotational speed at the various positions of the rotating motor is controlled based on the corrected reference speed.

In a further exemplary implementation, the correcting of the reference speed comprises correcting the reference speed using the rotational speed at the respective positions of the rotating motor using the following equation,
V_{new}=V_{ref}−A*Dif[n % N]

where V_{new} denotes a new reference speed after correction, V_{ref} denotes the reference speed before correction, A denotes a constant, n denotes a current position of the motor, N denotes a number of divided positions of the rotating motor, and Dif[n % N] denotes the measured rotational speed corresponding to the current position of the rotating speed.

In an exemplary implementation, the measuring of the rotational speed comprises reading a plurality of divided parts on a wheel mounted around a rotating axis of the motor by means of an encoder to measure the rotational speed of the motor.

In another exemplary implementation, the measuring of the rotational speed comprises measuring the rotational speed at the various positions of the rotating motor during one revolution of the motor when power is applied to the motor.

According to still another aspect of exemplary embodiments of the present invention, there is provided a computer-readable recording medium having embodied thereon a computer program for a method of controlling a motor.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a graph illustrating rotational speed with respect to position of a motor controlled by a conventional motor control apparatus and method;

FIG. 2 is a block diagram of a motor control apparatus according to an exemplary embodiment of the present invention;

FIG. 3 is a flowchart illustrating a motor control method according to an exemplary embodiment of the present invention;

FIGS. 4A and 4B are diagrams of a speed measuring unit of the motor control apparatus of FIG. 2;

FIG. 5 is a graph illustrating rotational speed with respect to position measured by the speed measuring unit 200 of FIGS. 4A and 4B;

FIG. 6 is a graph illustrating rotational speed with respect to position detected by a speed change detecting unit 210 of the motor control apparatus of FIG. 2;

FIG. 7A is a graph illustrating the rotational speed of a motor controlled by the conventional motor control apparatus and method; and

FIG. 7B is a graph illustrating the rotational speed of a motor controlled by the motor control apparatus and method according to an exemplary embodiment of the present invention.

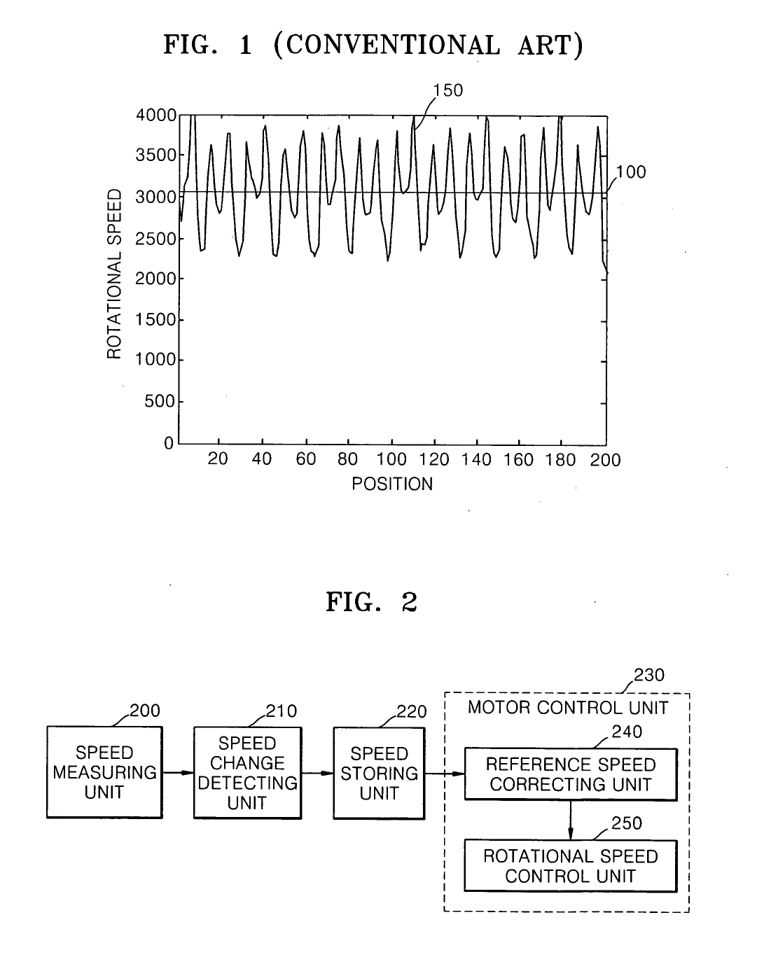

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a block diagram of a motor control apparatus according to an exemplary embodiment of the present invention. The motor control apparatus comprises a speed measuring unit 200, speed change detecting unit 210, speed storing unit 220, and motor control unit 230. The motor control unit 230 comprises a reference speed correcting unit 240 and a rotational speed control unit 250.

While the motor rotates experimentally, the speed measuring unit 200 measures the rotational speed when the rotating motor is at various positions. For example, when power is applied to the motor, the speed measuring unit 200 measures the rotational speed of the motor at various positions during each revolution.

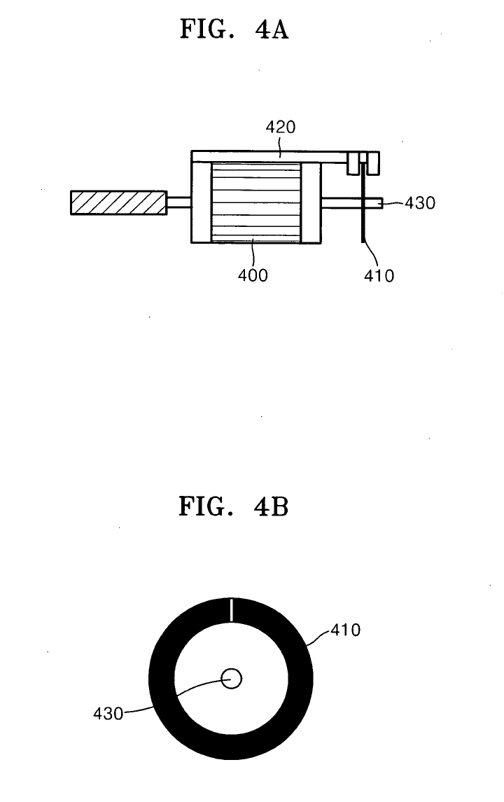

FIGS. 4A and 4B are diagrams of the speed measuring unit 200 of the motor control apparatus of FIG. 2. The speed measuring unit 200 comprises a motor 400, wheel 410, encoder 420, and shaft 430.

The speed measuring unit 200 reads combination patterns of the wheel 410 mounted on the same rotating axis as the shaft 430 by the encoder 420 to measure the rotational speed of the motor.

The combination patterns include transparent segments and are created on the wheel 410, which is a glass disk, such that the wheel 410 is divided into a plurality of parts indicating positions of the rotating motor.

The encoder 420 optically detects the combination patterns on the wheel 410 as binary data.

For example, when the wheel 410 includes 334 counts per revolution (cpr), that is, 334 transparent segments, and the encoder 420 includes two channels, the speed measuring unit 200 measures the rotational speed of the motor at 1336 (334×4) positions of the motor.

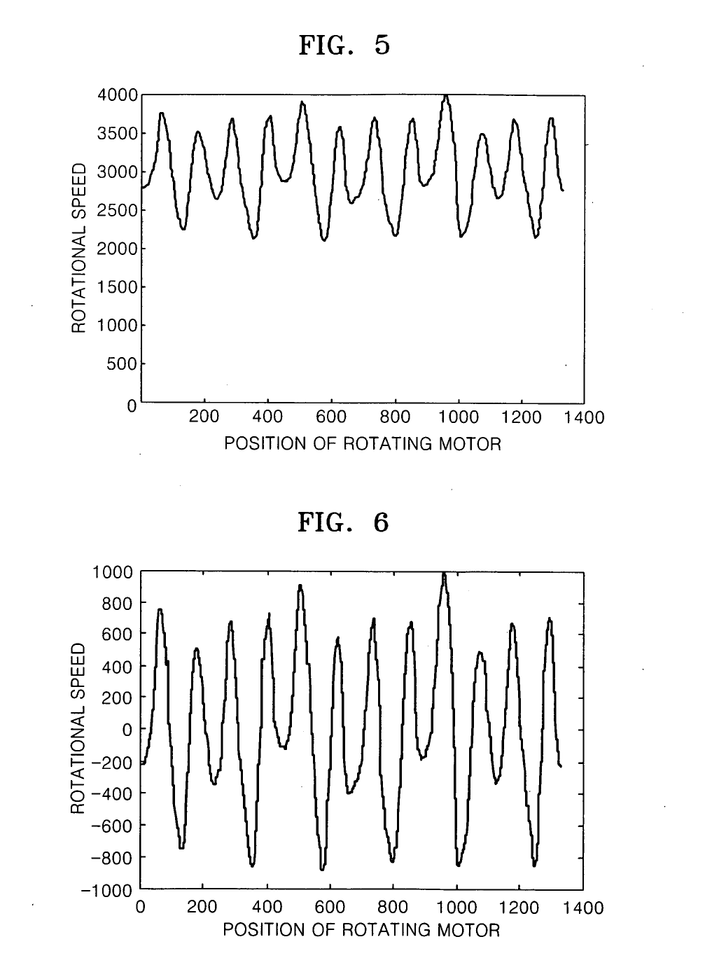

FIG. 5 is a graph illustrating the rotational speed measured by the speed measuring unit 200 with respect to the positions of the rotating motor. When one revolution of the motor is divided into a predetermined number of positions, the divided positions are assigned specific addresses.

The speed change detecting unit 210 detects changes in the rotational speed due to a cogging torque based on the rotational speed measured by the speed measuring unit 200.

The speed change detecting unit 210 calculates an average value of the rotational speed measured by the speed measuring unit 200 during one experimental revolution of the motor, and calculates a difference between the average value and the rotational speed measured by the speed measuring unit 200 at various positions to detect variations in the rotational speed due to the cogging torque.

Alternatively, the speed change detecting unit 210 calculates a difference between a reference speed used to control the motor and the rotational speed measured by the speed measuring unit 200 at various positions to detect the variations in the rotational speed due to the cogging torque.

FIG. 6 is a graph illustrating the rotational speed detected by the speed change detecting unit 210 with respect to the positions of the rotating motor.

The speed storing unit 220 stores the rotational speed in addresses corresponding to the positions of the rotating motor detected by the speed change detecting unit 210. For example, when the speed measuring unit 200 separates the position of the rotating motor into N positions and measures the rotational speed of the motor, the speed change detecting unit 210 detects the rotational speed at the N positions of the rotating motor. The speed storing unit 220 then sequentially stores the detected rotational speed as Dif[0]˜Dif[N−1].

The motor control unit 230 controls the rotational speed at the positions of the rotating motor based on the rotational speed values stored in the speed storing unit 220.

The motor control unit 230 comprises the reference speed correcting unit 240 and the rotational speed control unit 250.

The reference speed correcting unit 240 reads the rotational speed values stored in the speed storing unit 220 and corrects the reference speed based on the read rotational speed values. The reference speed correcting unit 240 changes the rotational speed values read from the speed storing unit 220 using a 180-degree phase difference and adds the changed value to the reference speed to correct the reference speed.

The reference speed correcting unit 240 corrects the reference speed using the rotational speed measured at the respective positions of the rotating motor using the following equation,
V_{new}=V_{ref}−A*Dif[n % N] (1)

where V_{new} denotes a new reference speed after correction, V_{ref} denotes the reference speed before correction, N denotes a number of positions of the motor, n denotes a current position of the motor, n % N denotes a current position of the motor for the rotation period of the motor, Dif[n % N] denotes a rotational speed stored in the speed storing unit 230 corresponding to the current position of the rotating motor for the rotation period of the motor, and A denotes a constant used to correct ripples generated due to a cogging torque. The constant A is set to a value that results in the fewest ripples through experiment.

The rotational speed control unit 250 controls the rotational speed of the motor based on the reference speed corrected by the reference speed correcting unit 240.

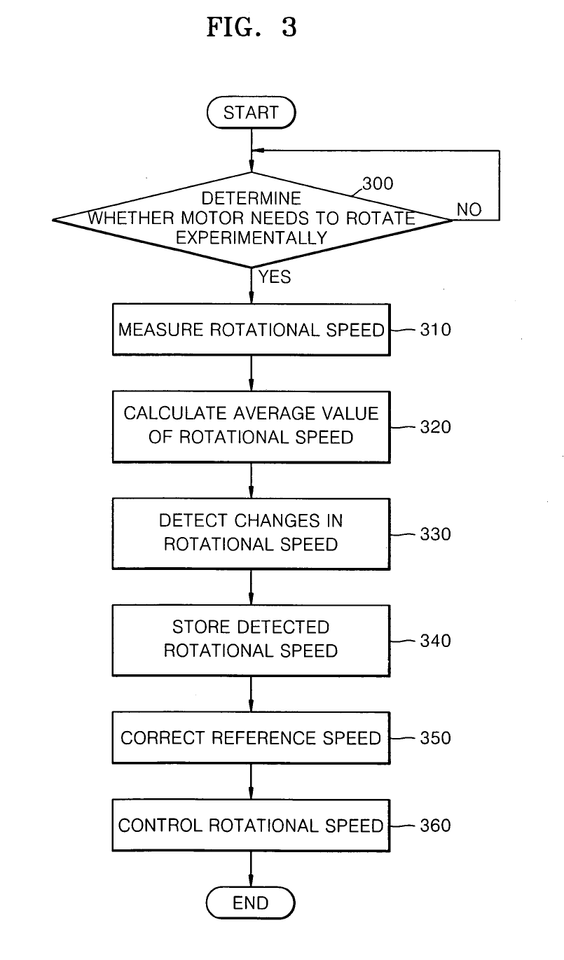

FIG. 3 is a flowchart illustrating a motor control method according to an exemplary embodiment of the present invention.

In operation 300, a determination is made as to whether the motor needs to rotate experimentally to measure the rotational speed of the motor. The motor may rotate experimentally when power is applied to the motor.

If a determination is made in operation in 300 that the motor needs to rotate experimentally, the process goes to operation 310. In operation 310, the motor rotates once and the rotational speed at regular positions of the rotating motor is measured.

In operation 320, an average value of the rotational speed values measured in operation 310 during one experimental revolution of the motor is calculated.

In operation 330, a difference between the average value calculated in operation 320 and the rotational speed at each position measured in operation 310 is calculated to detect variations in the rotational speed due to a cogging torque.

Alternatively, in operations 320 and 330, a difference between a reference speed and the rotational speed at each position measured in operation 310 may be calculated to detect variations in the rotational speed due to a cogging torque.

In operation 340, the rotational speed values detected in operation 330 are stored in a storage medium such as a memory. For example, when the position of the rotating motor is divided into N positions and the rotational speed of the motor is measured in operation 310, the rotational speed values detected at the respective positions of the rotating motor are sequentially stored as Dif[0]˜Dif[N−1] in operation 340.

In operation 350, the stored rotational speed values are read and the reference speed is corrected based on the read rotational speed values. In operation 350, the rotational speed values stored in operation 340 are changed using a 180-degree phase difference and then added to the reference speed to correct the reference speed.

In operation 350, the reference speed is corrected using the reference speed measured at the respective positions of the rotating motor using the following equation,
V_{new}=V_{ref}−A*Dif[n % N] (2)

where V_{new} denotes a new reference speed after correction, V_{ref} denotes the reference speed before correction, N denotes the number of positions of the motor, n % N denotes a current position of the motor for the rotation period of the motor, Dif[n % N] denotes a rotational speed stored in operation 340 corresponding to the current position of the rotating motor, and A denotes a constant used to correct ripples generated due to a cogging torque. The constant A is set to a value that results in the fewest ripples through experiment.

In operation 360, the rotational speed of the motor is controlled based on the reference speed corrected in operation 350.

The present invention may be implemented as computer-readable code on computer-readable recording media. The computer-readable recording media comprises various recording devices which data readable by computer systems are stored. Examples of the computer-readable recording media comprise ROMs, RAMs, CD-ROMs, magnetic tapes, floppy disks, and optical data storages.

The motor control apparatus and method according to exemplary embodiments of the present invention are used to control a motor by experimentally rotating the motor, detecting changes in the rotational speed due to a cogging torque, and correcting the rotational speed of the motor at positions of the rotating motor.

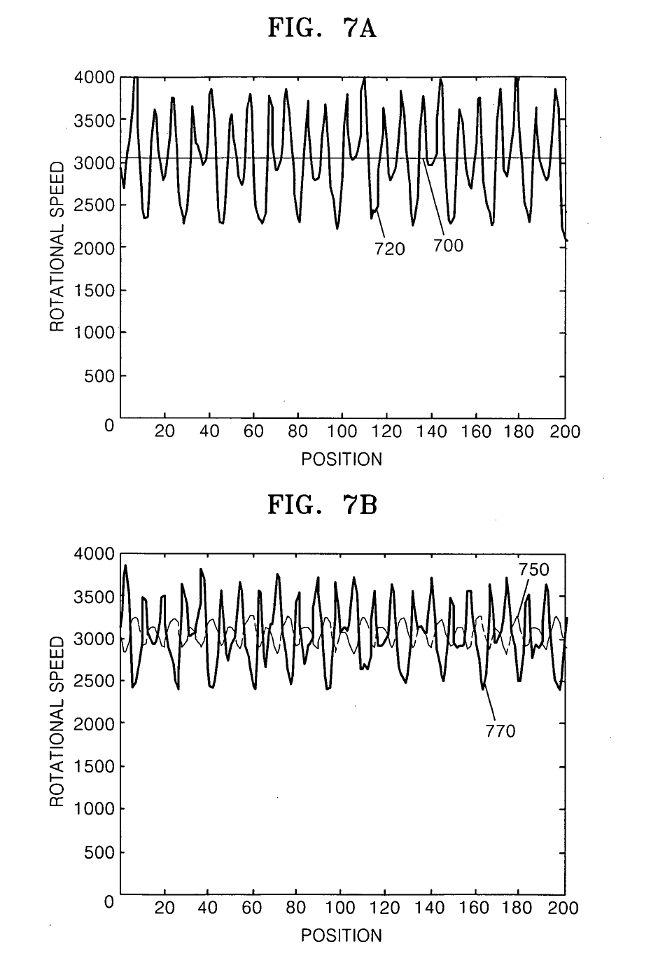

FIG. 7A is a graph illustrating the rotational speed of a motor controlled by a conventional motor control apparatus and method. FIG. 7B is a graph illustrating the rotational speed of the motor controlled by the motor control apparatus and method according to an exemplary embodiment of the present invention.

Reference numerals 700 and 750 denote reference speeds for the control of the motor, and reference numerals 720 and 770 denote the real rotational speed of the motor. The conventional motor control apparatus and method produces rotational speed ripples varying by as much as 17% from the reference speed due to a cogging torque, whereas the motor control apparatus and method according to an exemplary embodiment of the present invention produces rotational speed ripples varying by as much as 12% from the reference speed due to a cogging torque, which is 5% lower than resulting speed ripples in conventional art.

As a result, the motor control apparatus and method of exemplary embodiments of the present invention may precisely control the speed and position of the motor. Also, print quality deterioration in an image forming apparatus due to rotational speed ripples may be effectively avoided.

While the invention has been shown and described with reference to certain exemplary embodiments thereof, it will be understood by those skill in the art that various changes in form and details may be made therein without departing from the spirit and scope of the invention as defined by the appended claims.

What is claimed is:

1. An apparatus for controlling a motor, the apparatus comprising:
a speed measuring unit for measuring a rotational speed of a motor at various positions during a revolution of the motor;
a speed change detecting unit for detecting changes in the rotational speed of the motor at the various positions of the motor rotating due to a cogging torque based on the measured rotational speed;
a speed storing unit for storing the measured rotational speed for the various positions of the rotating motor in addresses corresponding to the various positions of the rotating motor; and
a motor control unit for controlling the rotational speed of the motor at the various positions of the rotating motor based on the stored rotational speed.

2. The apparatus of claim 1, wherein the speed change detecting unit calculates an average value of the rotational speed measured during the revolution of the motor, and calculates a difference between the average value and the measured rotational speed to detect changes in the rotational speed.

3. The apparatus of claim 1, wherein the speed change detecting unit calculates a difference between a reference speed for the control of the motor and the measured rotational speed to detect the changes in the rotational speed.

4. The apparatus of claim 1, wherein the motor control unit comprises:
a reference speed correcting unit for correcting a reference speed for the control of the motor based on the stored rotational speed at the various positions of the rotating motor; and
a rotational speed control unit for controlling the rotational speed at the various positions of the rotating motor based on the corrected reference speed.

5. The apparatus of claim 4, wherein the reference speed correcting unit corrects the reference speed using the rotational speed measured at respective positions of the rotating motor using the following equation,
V_{new}=V_{ref}−A*Dif[n % N]
wherein V_{new} denotes a new reference speed after correction, V_{ref} denotes the reference speed before correction, A denotes a constant, n denotes a current position of the motor, N denotes a number of divided positions of the rotating motor, and Dif[n % N] denotes the measured rotational speed corresponding to the current position of the rotating motor.

6. The apparatus of claim 1, wherein the speed measuring unit reads at least one divided part on a wheel mounted around a rotating axis of the motor by an encoder to measure the rotational speed of the motor.

7. The apparatus of claim 1, wherein, when power is applied to the motor, the speed measuring unit measures the rotational speed at the positions of the rotating motor during one revolution of the motor.

8. A method of controlling a motor, comprising:
measuring the rotational speed of the rotating motor at various positions during a revolution of the motor;
detecting changes in the rotational speed of the motor at the various positions due to a cogging torque based on the measured rotational speed;
storing the measured rotational speed for the various positions of the rotating motor in addresses corresponding to the various positions of the motor rotating; and
controlling the rotational speed of the motor at the various positions of the rotating motor based on the stored rotational speed.

9. The method of claim 8, wherein the detecting of the rotational speed comprises calculating an average value of the rotational speed measured during the revolution of the motor, and calculating a difference between the average value and the measured rotational speed to detect changes in the rotational speed.

10. The method of claim 8, wherein the detecting of the rotational speed comprises calculating a difference between a reference speed for the control of the motor and the measured rotational speed to detect the changes in the rotational speed.

11. The method of claim 8, wherein the controlling of the rotational speed comprises:
correcting a reference speed for the control of the motor based on the stored rotational speed at the various positions of the rotating motor; and
controlling the rotational speed at the various positions of the rotating motor based on the corrected reference speed.

12. The method of claim 11, wherein the correcting of the reference speed comprises correcting the reference speed using the rotational speed at respective positions of the rotating motor using the following equation,
V_{new}=V_{ref}−A*Dif[n % N]
wherein V_{new} denotes a new reference speed after correction, V_{ref} denotes the reference speed before correction, A denotes a constant, n denotes a current position of the motor, N denotes a number of divided positions of the rotating motor, and Dif[n % N] denotes the measured rotational speed corresponding to the current position of the rotating speed.

13. The method of claim 8, wherein the measuring of the rotational speed comprises reading at least one divided part on a wheel mounted around a rotating axis of the motor by an encoder to measure the rotational speed of the motor.

14. The method of claim 8, wherein the measuring of the rotational speed comprises measuring the rotational speed at the various positions of the rotating motor during one revolution of the motor when power is applied to the motor.

15. A computer-readable recording medium comprising a computer program for the method according to claim 8.
